(19) United States
(12) Patent Application Publication
(10) Pub. No.: US 2021/0355342 A1
(43) Pub. Date: Nov. 18, 2021

(54) BIO-SECURE PROTECTIVE EQUIPMENT AND METHODS FOR MAKING

(71) Applicant: KRATON POLYMERS LLC, Houston, TX (US)

(72) Inventors: Vijay Mhetar, Houston, TX (US); Richard Blackwell, Houston, TX (US); Marc Charendoff, Houston, TX (US); Marc Hein, Houston, TX (US); Bert Krutzer, Amsterdam (NL); Roger Tocchetto, Houston, TX (US); Xiangyun Wei, Houston, TX (US); Carl L. Willis, Houston, TX (US); Richard J. Spontak, Raleigh, NC (US); Bharadwaja Peddinti, Houston, TX (US)

(73) Assignee: KRATON POLYMERS LLC, Houston, TX (US)

(21) Appl. No.: 17/301,935

(22) Filed: Apr. 19, 2021

Related U.S. Application Data
(60) Provisional application No. 62/704,479, filed on May 12, 2020.

(51) Int. Cl. C09D 153/00

(52) U.S. Cl. CPC C09D 153/005

(57) ABSTRACT

The disclosure relates to bio-secure equipment for protecting surfaces prone to exposure to microbes. The bio-secure equipment is for the protection of surfaces, with a coating layer comprising a sulfonated polymer, having a sufficient degree of sulfonation to kill in less than 120 minutes at least 90% of microbes in contact with the surfaces, and for extended protection of the surfaces for at least a month. The coating material is particularly suitable to provide bio-secure protection for applications including but not limited to protective facemasks, surgical instruments and supplies, garments, surfaces frequently used by members of the public that may have contagious diseases, etc., to decrease the transmission of microbes.

### TECHNICAL FIELD

The disclosure relates to bio-secure protective equipment for protecting surfaces from infectious and/or contagious diseases, coating materials for protecting surfaces, and methods for providing surfaces with antimicrobial protective coating for killing microbes.

### BACKGROUND

Drug-resistant microbes are becoming a threat to global health care, particularly with the risk of hospital-acquired infections that could become fatal. Besides health care workers, public safety officers (e.g., emergency medical technicians, police officers, etc.) often are exposed to the public, some of which may have infectious and/or contagious disease, with the risk of infecting themselves or infecting others among the healthy population subsequent to their contact with infectious and/or contagious individuals.

In the context of pandemics, phone booth style testing facilities have been set up to allow medical staff to examine patients from behind the safety of a plastic panel. After each patient testing, the booth is then disinfected and ventilated. It is desirable to have medical facilities, examining rooms, etc., that do not require shut-down in between patients for sterilizing, particularly when hospitals and emergency rooms are overwhelmed with patients.

Also in the context of pandemics, health organizations and government entities have either recommended or mandated that facemasks be worn in public. Facemasks can be identified by their protection efficiency, e.g., N90, N95 and N100, referring to the filtering efficiency of particulates of at least 0.3 μm in diameter. Vesicular stomatitis virus (VSV), an enveloped virus with bullet-shaped virions, measures 70×200 nanometers. SARS-CoV-2 measures ˜0.125 micron (125 nanometers) in diameter, released even in simple breathing and talking. A facemask is desirable to provide protection from the spreading of respiratory illnesses due to breathing in viruses. In a pandemic, shortage of PPE (personal protective equipment) such as respirators and surgical facemasks can occur, requiring re-use of single-use PPEs, risking infection. Methods have been developed to clean facemasks for re-use by health care works in hospitals, e.g., the use of vaporized H₂O₂. There are also home-made solutions to clean and sterilize facemasks for re-use, with uncertain outcome as to their effectiveness.

In the prior art, several microbiocidal approaches have been adopted, including the use of metals, metal oxide nanoparticles, metal salts, and cationic polymers to provide antimicrobial properties for coating surfaces. However, bacteria can build up resistance to metals over time. There is also a significant environmental impact as nanoscale metal can leach into the environment and contaminate the food chain or directly enter into higher-level organisms at the subcellular level.

Cationic polymers are a class of polymers bearing a positive charge or incorporating cationic entities in their structure. The antimicrobial activity of cationic polymers is related to many factors, including morphology, size and surface charge. The most common mechanism at the origin of the antimicrobial activity of this class of materials is the interaction between their positively charged structure and the negatively charged microorganism's membrane. After adsorption on the cell wall, the polymer can diffuse and cause its rupture. Some cationic antimicrobial polymers have been shown to kill 90%-99% of Gram-negative and Gram-positive bacteria, through either air or water. However, a major disadvantage of cationic antimicrobial polymers is that the macromolecules can be very large. Thus they may not act as fast as small molecule agents. Some require contact times on the order of hours to provide substantial reductions in pathogens, not applicable for routine use by hospitals, clinics, and other facilities handling patients that may have infectious and/or contagious disease. Another disadvantage is these polymers may be ineffective against viruses without the negatively charged phospholipid membranes.

There is a need for extended use PPE, e.g., face masks, that is self-sterilizing, i.e., having the capability to quickly kill microbes, for extended protection for health care workers, public safety workers, as well as the public in general. There is a need for filtration media that is self-sterilizing for extended protection in healthcare facilities and in residences, especially for those with debilitated immune systems. Such filtration media can be air conditioning filters, energy recovery units, devices designed to control environmental humidity (humidifiers and dehumidifiers), process air in sterile environments, vehicular ventilation systems, among many others. There is a need for self-sterilizing fabrics (including clothing and garments for personal or medical patient use), as well as furniture and furniture components such as cushions, fillers, and padding for residential, healthcare or commercial use. Further, there is a need for self-sterilizing coatings on surfaces people tend to touch regularly such as on electronics, hand rails, door knobs, handles, faucets, automotive and aircraft interiors, luggage and hand bags, (credit) cards and card readers, wallets, keys, counters and containers, office supplies such as pens, markers, rulers, among many others.

There is a need for equipment with the potential for exposure to microbes being protected with a bio-secure surface that would inherently, quickly, and efficiently kill the microbes upon contact with its protective surfaces and over repeated exposures, allowing extended use of equipment.

### SUMMARY

In one aspect, the disclosure relates to a bio-secure coating material that decreases the transmission of one or more than one pathogen by antimicrobial activities. The coating material comprises, consists essentially of, or consists of a sulfonated polymer selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof. The sulfonated polymer contains from 10-100 mol % sulfonic acid or sulfonate salt functional groups based on the number of monomer units or blocks in the sulfonated polymer susceptible to sulfonation (i.e., can be sulfonated), for the coating material to kill at least 90% of microbes within 120 minutes of contact. The coating material is applied onto surfaces prone to microbial contamination for a thickness of at least >1 μm.

In some aspects, the coating material comprises at least 50 wt. %, more preferably at least 70 wt. %, even more preferably at least 90 wt. %, yet more preferably at least 95 wt. %, still more preferably at least 98 wt. %, even more preferably at least 99 wt. % and most preferably 100 wt. % (i.e. consists) of one or more of the sulfonated polymers.

In embodiments, the sulfonated polymer has a degree of sulfonation of at least 20%. In embodiments, the sulfonated polymer has an ionic exchange capacity (IEC) of at least 0.5 meq/g. In embodiments, the coating material has acidic impurities of less than 1000 ppm. In embodiments, the sulfonated polymer is a sulfonated tetrafluoroethylene.

In embodiments, herein the coating material is periodically reactivated by exposure to an acidic solution of having a concentration of >0.1M, or >0.5M, or >0.75M, or >1M for at least 5 minutes, or 10 minute, or 10-45 minutes.

In embodiments, the sulfonated polymer is a selectively sulfonated negative-charged anionic block copolymer. The copolymer has a general configuration of: A-B-A, (A-B)n(A), (A-B-A)n, (A-B-A)ₙX, (A-B)nX, A-D-B, A-B-D, A-D-B-D-A, A-B-D-B-A, (A-D-B)ₙA, (A-B-D)ₙA (A-D-B)ₙX, (A-B-D)ₙX or mixtures thereof, wherein: n is an integer from 0 to 30, X is a coupling agent residue, each A and D block is a polymer block resistant to sulfonation, each B block is susceptible to sulfonation. In embodiments with plurality of A, B or D blocks, the A block, the B block, and the D block can be the same or different. The A block is selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof. The B block is a vinyl aromatic monomer. The D block is a hydrogenated polymer or copolymer of a conjugated diene selected from isoprene, 1,3-butadiene and mixtures thereof. The block B is selectively sulfonated to contain from 10-100 mol % sulfonic acid or sulfonate salt functional groups based on the number of monomer units, for killing at least 99% of microbes within 30 minutes of coming into contact with the coating material.

In other embodiments, the sulfonated polymer is a selectively sulfonated negative-charged anionic block copolymer, having at least one alkenyl arene polymer block A and at least one substantially completely, hydrogenated conjugated diene polymer block B, with substantially all of the sulfonic functional groups grafted to alkenyl arene polymer block A with the block A being a hydrophilic end-block.

In one aspect, a coating material comprising a sulfonated polymer is applied onto surfaces prone to contamination as a film, or by any of any of dip coating, spray coating, electro-spinning, printing, 3-D printing, laminating, spin-coating, extruding, extrusion then followed by blow-molding, and combinations thereof. In embodiments, the coating material is applied onto surfaces as a liquid, a gel, a foam, a spray, an emulsion, a solution, a film, a membrane, or a laminate to form a coating layer having a thickness of 1 μm, or >5 μm, the coating material to kill at least 99% of microbes within 5 minutes of contact with the coating materials

In embodiments, the coating material is first dispersed in water or solvent for subsequent coating onto surfaces. In other embodiments, the coating material is subject to a washing process by rinsing in deionized water or alcohol to remove acidic impurities.

In another aspect, the disclosure relates to a method to provide bio-secure protection properties to surfaces prone to microbial contamination for an extended period of time, of up to 6 months. The method comprises applying onto surfaces prone to microbial contamination a coating layer comprising a sulfonated polymer. The sulfonated polymer has a sufficient degree of sulfonation to kill in less than 5 minutes at least 99% of microbes in contact with the surfaces.

In another aspect, the disclosure relates to a facial mask that decreases the transmission of one or more than one pathogen by antibacterial, antifungal and antiviral activity. The facial mask comprising a wearable structure configured for placement over a mouth and nose. The wearable structure having a filtering structure comprising at least a filter layer being coated with a sulfonated polymer. The filter layer kills at least 90% of microbes within 5 minutes of coming into contact with the filter layer.

In yet another aspect, the disclosure relates to a mobile bio-secure medical facility. The medical facility comprises: a patient transporter such as a stretcher, a cot or a hospital bed; a containment tent for patient seeking entry into the medical facility, wherein the patent may have a contagious disease. The containment tent is designed and constructed to be positioned on top of and secured to the patient transporter containing the patient transporter within interior of the containment tent. The containment tent has at least a wall being transparent-in-part, at least one glove formed in at least one of the transparent-in-part wall extending into the interior of the containment tent for examining and being in contact with the patient. The surface of the interior of the containment tent, exterior of the glove in contact with the patient, and the patient transporter is coated with a coating layer comprising a sulfonated polymer. The coating layer is of a sufficient thickness to kill at least 90% of microbes within 5 minutes of contact.

In another aspect, the disclosure relates to a method for decreasing the transmission of one or more than one pathogen by antibacterial, antifungal and antiviral activity surfaces from spreading. The method comprises coating on surfaces of equipment with a sufficient layer of a sulfonated polymer for the coating layer to kill at least 90% of microbes within 120 minutes of contact.

### DESCRIPTION

The following terms used the specification have the following meanings:

“Ion Exchange Capacity” or IEC refers to the total active sites or functional groups responsible for ion exchange in a polymer. Generally, a conventional acid-base titration method is used to determine the IEC, see for example International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which the weight of the polymer required to provide 1 mole of exchangeable protons.

“Anti-fog” refers to the prevention or inhibition of build-up of condensation on a surface (such as a lens or a window). Anti-fog property can be expressed by the value T_{fog}, which is the time it takes to form a fog on a surface. Anti-fog can be evaluated by exposing the layer (surface) to steam from boiling water at a 20 centimeter distance from the water's surface in an environment of 50% RH (relative humidity) and 22° C. For example, if the surface has a T_{fog} of 30 minutes, it means that no fog is formed on a surface of said coating within about 30 minutes under the testing conditions described.

“Microbes” refers to microorganisms including bacteria, archaea, fungi (yeasts and molds), algae, protozoa, and viruses, with microscopic size.

“Equipment,” or “equipment and gear,” or “gear,” refers to equipment and/or gear commonly used by health-care workers, or public safety personnel, in the treatment of or in contact with individuals who may have infectious and/or contagious diseases, e.g., personal protective equipment such as masks, respirators, protective garments, aprons, handles for instruments, electronic devices which are used in hospital rooms, hand rails, door handles/knobs and other common hand touching surfaces, etc., or for use in the transport, temporary hold, or receiving facilities, such as medical tents, cots,

“Bio-secure” refers to a material, a composition, or an article with deactivating, self-sterilizing/self-disinfecting properties, e.g., virucidal and bactericidal, with the capability to kill microbes and render them inert, or to essentially inhibit the attachment of microbes, upon contact for an extended period of time. In embodiments, the extended period of time is at least 2 hrs., or >4 hours, or >12 hrs., or up to 6 months. The sulfonated polymer can be reactivated to have its bio-secure properties being regenerated with a regenerating or recharging process step.

“Self-sterilizing” means a material, a composition, or an article with disinfecting properties, e.g., virucidal and bactericidal, with the capability to kill >99% of microbes and render them inert, or to essentially inhibit the attachment of microbes, upon contact in a short period of time, e.g., less than 120 minutes, less than 30 minutes, or less than 10 minutes, or less than 5 minutes, and with the capability to stay bio-secure for an extended period of time. In embodiments, the extended period of time is at least 2 hrs., or at least 4 hrs., or at least 12 hrs. The term self-sterilizing may be used interchangeably with antimicrobial, or bio-secure.

“Regenerating,” “regeneration,” or “reactivating,” or “recharging” (and the passive form thereof) refers to a process to charge or recharge, or a state of being charged or recharged to enhance or restore the bio-secure properties to kill or inactivate microbes upon contact.

“Effective amount” refers to an amount sufficient to alter, destroy, inactivate, and/or neutralize microbes, e.g., an amount sufficient to sterilize and kill the microbes.

“Surface pH” refers to the pH on the contact surface of the sulfonated polymer, that results from surface bound moieties e.g., the coating layer. The surface pH can be measured with commercial surface pH measuring instruments, e.g., SenTix™ Sur-electrode from WTW Scientific-Technical Institute GmbH, Weilheim, Germany.

“Releasable” or “separable” bond in the context of layers or surfaces means that the layers or surfaces are generally attached or fastened to each other, yet can be separated with the application of a certain amount of force, and then subsequently refastened or reattached at a later time. In order to be “separable” or “releasable,” the surfaces must be capable of being fastened and separated, and the force applied to separate the layers or surfaces can be applied by hand.

“High-touch Surfaces” refers to surfaces that are handled frequently throughout the day by numerous people (according definition of the US Centers for Disease Control and Prevention).

The disclosure relates to equipment having at least a surface coated with, or protected by a material containing a sulfonated polymer for self-sterilizing effects, i.e., killing microbes upon contact. In embodiments, the surface is coated with a composition comprises, consists essentially of, or consists of the sulfonated polymer. The sulfonated polymer is characterized as having bio-secure properties, particularly suitable for contact with living things, e.g., individuals, animals, that may have infectious and/or contagious diseases, or surfaces or substances that may be exposed to microbes causing infectious and/or contagious diseases.

Self-sterilizing Material—Sulfonated Polymer: Sulfonated polymer refers to polymers having a sulfonate group, e.g., —SO₃, either in the acid form (e.g., —SO₃H, sulfonic acid) or a salt form (e.g., —SO₃Na). The term “sulfonated polymer” also covers sulfonate containing polymers, e.g., polystyrene sulfonate.

The sulfonated polymer is selected from the group of perfluorosulfonic acid polymers (e.g., sulfonated tetrafluoroethylene), sulfonated polyolefins, sulfonated polyimides, sulfonated polyamides, sulfonated polyester, polystyrene sulfonates, sulfonated block copolymers, sulfonated polyolefins, sulfonated polysulfones such as polyether sulfone, sulfonated polyketones such as polyether ether ketone, sulfonated polyphenylene ethers, and mixtures thereof.

The sulfonated polymer is characterized as being sufficiently or selectively sulfonated to contain from 10-100 mol % sulfonic acid or sulfonate salt functional groups based on the number of monomer units or the block to be sulfonated (“degree of sulfonation”), to kill at least 95% of microbes within 120 minutes of coming into contact with the coating material. In embodiments, the sulfonated polymer has a degree of sulfonation of >25 mol %, or >50 mol %, or <95 mol %, or 25-70 mol %. Degree of sulfonation can be calculated by NMR or ion exchange capacity (IEC).

In embodiments, the sulfonated polymer is a sulfonated tetrafluoroethylene, having a polytetrafluoroethylene (PTFE) backbone; (2) side chains of vinyl ethers (e.g., —O—CF₂—CF—O—CF₂—CF₂—) which terminate in sulfonic acid groups in a cluster region.

In embodiments, the sulfonated polymer is a polystyrene sulfonate, examples include potassium polystyrene sulfonate, sodium polystyrene sulfonate, a co-polymer of sodium polystyrene sulfonate and potassium polystyrene sulfonate (e.g., a polystyrene sulfonate copolymer), having a molecular weight of 20,000 to 1,000,000 Daltons, or >25,000 Daltons, or >40,000 Dalton, or >50,000, or >75,000, or >100,000 Daltons, or >400,000 Daltons, or <200,000, or <800,000 Daltons, or up to 1,500,000 Daltons. The polystyrene sulfonate polymers can either be crosslinked or uncrosslinked. In embodiments, the polystyrene sulfonate polymers are uncrosslinked and water soluble.

In embodiments, the sulfonated polymer is a polysulfone, selected from the group of aromatic polysulfones, polyphenylenesulfones, aromatic polyether sulfones, dichlorodiphenoxy sulfones, sulfonated substituted polysulfone polymers, and mixtures thereof. In embodiments, the sulfonated polymer is a sulfonated polyethersulfone copolymer, which can be made with reactants including sulfonate salts such as hydroquinone 2-potassium sulfonate (HPS) with other monomers, e.g., bisphenol A and 4-fluorophenyl sulfone. The degree of sulfonation in the polymer can be controlled with the amount of HPS unit in the polymer backbone.

In embodiments, the sulfonated polymer is a sulfonated polyether ketone. In embodiments, the sulfonated polymer is a sulfonated polyether ketone ketone (SPEKK), obtained by sulfonating a polyether ketone ketone (PEKK). The polyether ketone ketone can be manufactured using diphenyl ether and a benzene dicarbonic acid derivative. The sulfonated PEKK can be available as an alcohol and/or water-soluble product, e.g., for subsequent use to coat the face mask or in spray applications.

In embodiments, the sulfonated polymer is a sulfonated poly(arylene ether) copolymer containing pendant sulfonic acid groups. In embodiments, the sulfonated polymer is a sulfonated poly(2,6-dimethyl-1,4-phenylene oxide), commonly referred to as sulfonated polyphenylene oxide. In embodiments, the sulfonated polymer is a sulfonated poly(4-phenoxybenzoyl-1,4-phenylene) (S-PPBP). In embodiments, the sulfonated polymer is a sulfonated polyphenylene having 2 to 6 pendant sulfonic acid groups per polymer repeat, and characterized as having 0.5 meq (SO₃H)/g of polymer to 5.0 meq (SO₃H)/g polymer, or at least 6 meq/g (SO₃H)/g polymer.

In embodiments, the sulfonated polymer is a sulfonated polyamide, e.g. aliphatic polyamides such nylon-6 and nylon-6,6, partially aromatic polyamides and polyarylamides such as poly(phenyldiamidoterephthalate), provided with sulfonate groups chemically bonded as amine pendant groups to nitrogen atoms in the polymer backbone. The sulfonated polyamide can have a sulfonation level of 20 to up to 100% of the amide group, with the sulfonation throughout the bulk of the polyamide. In embodiments, the sulfonation is limited to a high density of sulfonate groups at the surface, e.g., >10%, >20%, >30%, or >40%, or up to 100% of the sulfonated amide group at the surface (within 50 nm of the surface).

In embodiments, the sulfonated polymer is a sulfonated polyolefin, containing at least 0.1 meq, or >2 meq, or >3 meq, or >5 meq, or 0.1 to 6 meq of sulfonic acid per gram of polyolefin. In embodiments, the sulfonated polymer is a sulfonated polyethylene. The sulfonated polyolefin can be formed by chlorosulfonation of a solid polyolefin obtained by polymerization of an olefin or a mixture of olefins selected from a group consisting of ethylene, propylene, butene-1,4-methylpentene-1, isobutylene, and styrene. The sulfonyl chloride groups can then be hydrolyzed, for example, in an aqueous base such as potassium hydroxide or in a water dimethylsulfoxide (DMF) mixture to form sulfonic acid groups. In embodiment, the sulfonated polyolefin is formed by submerging or passing polyolefin object in any form of powder, fiber, yarn, woven fabric, a film, a preform, etc., through a liquid containing sulfur trioxide (SO₃), a sulfur trioxide precursor (e.g., chlorosulfonic acid, HSO₃Cl), sulfur dioxide (SO₂), or a mixture thereof. In other embodiments, the polyolefin object is brought into contact with a sulfonating gas, e.g., SO₂ or SO₃, or gaseous reactive precursor, or a sulfonation additive that evolves a gas SOₓ at elevated temperature.

The polyolefin precursor to be sulfonated can be, for example, a poly-α-olefin, such as polyethylene, polypropylene, polybutylene, polyisobutylene, ethylene propylene rubber, or a chlorinated polyolefin (e.g., polyvinylchloride, or PVC), or a polydiene, such as polybutadiene (e.g., poly-1,3-butadiene or poly-1,2-butadiene), polyisoprene, dicyclopentadiene, ethylidene norbornene, or vinyl norbornene, or a homogeneous or heterogeneous composite thereof, or a copolymer thereof (e.g., EPDM rubber, i.e., ethylene propylene diene monomer). In embodiments, the polyolefin is selected from low density polyethylene (LDPE), linear low density polyethylene (LLDPE), very low density polyethylene (VLDPE), high density polyethylene (HDPE), medium density polyethylene (MDPE), high molecular weight polyethylene (HMWPE), and ultra-high molecular weight polyethylene (UHMWPE).

In embodiments, the sulfonated polymer is a sulfonated polyimide, e.g., aromatic polyimides in both thermoplastic and thermosetting forms, having excellent chemical stability and high modulus properties. Sulfonated polyimide can be prepared by condensation polymerization of dianhydrides with diamines, wherein one of the monomeric units contains sulfonic acid, sulfonic acid salt, or sulfonic ester group. The polymer can also be prepared by direct sulfonation of aromatic polyimide precursors, using sulfonation agents such as chlorosulfonic acid, sulfur trioxide and sulfur trioxide complexes. In embodiments, the concentration of sulfonic acid groups in the sulfonated polyimide as measured by ion exchange capacity, IEC, varying from 0.1 meq/g to above 3 meq/g, or at least 6 meq/g.

In embodiments, the sulfonated polymer is a sulfonated polyester, formed by directly sulfonating a polyester resin in any form, e.g., fiber, yarn, woven fabric, film, sheet, and the like, with a sulfuric anhydride-containing gas containing sulfuric anhydride, for a concentration of the sulfone group on the surface of the polyester ranging from 0.1 meq/g to above 3 meq/g, e.g., up to 5 meq/g, or at least 6 meq/g.

In embodiments, the sulfonated polymer is a selectively sulfonated negative-charged anionic block copolymer. The term “selectively sulfonated” definition to include sulfonic acid as well as neutralized sulfonate derivatives. The sulfonate group can be in the form of metal salt, ammonium salt or amine salt.

Depending on the applications and the desired properties, the sulfonated polymer can be modified (or functionalized). In embodiments, the sulfonated polymer is neutralized with any of various metal counterions, including alkali, alkaline earth, and transition metals, with at least 10% of the sulfonic acid groups being neutralized. In embodiments, the sulfonated polymer is neutralized with inorganic or organic cationic salts, e.g, those based on ammonium, phosphonium, pyridinium, sulfonium and the like. Salts can be monomeric, oligomeric, or polymeric. In embodiments, the sulfonated polymer is neutralized with various primary, secondary, or tertiary amine-containing molecules, with >10% of the sulfonic acid or sulfonate functional groups being neutralized.

In embodiments, the sulfonic acid or sulfonate functional group is modified by reaction with an effective amount of polyoxyalkyleneamine having molecular weights from 140 to 10,000. Amine-containing neutralizing agents can be mono-functional or multi-functional; monomeric, oligomeric, or polymeric. In alternative embodiments, the sulfonated polymer is modified with alternative anionic functionalities, such as phosphonic acid or acrylic and alkyl acrylic acids.

In embodiments, amine containing polymers are used for the modification of the sulfonated polymers, forming members of a class of materials termed coaservates. In examples, the neutralizing agent is a polymeric amine, e.g., polymers containing benzylamine functionality. Examples include homopolymers and copolymers of 4-dimethylaminostyrene which has been described in U.S. Pat. No. 9,849,450, incorporated herein by reference. In embodiments, the neutralizing agents are selected from polymers containing vinylbenzylamine functionality, e.g., polymers synthesized from poly-p-methylstyrene containing block copolymers via a bromination-amination strategy, or by direct anionic polymerization of amine containing styrenic monomers. Examples of amine functionalities for functionalization include but are not limited to p-vinylbenzyldimethylamine (BDMA), p-vinylbenzylpyrrolidine (VBPyr), p-vinylbenzyl-bis(2-methoxyethyl)amine (VBDEM), p-vinylbenzylpiperazine (VBMPip), and p-vinylbenzyldiphenylamine (VBDPA). In embodiments, corresponding phosphorus containing polymers can also be used for the functionalization of the sulfonated polymers.

In embodiments, the monomer or the block containing amine functionality or phosphine functionality can be neutralized with acids or proton donors, creating quaternary ammonium or phosphonium salts. In other embodiments, the sulfonated polymer containing tertiary amine is reacted with alkylhalides to form functional groups, e.g., quaternized salts. In some embodiments, the sulfonated polymer can contain both cationic and anionic functionality to form so-called zwitterionic polymers.

In some embodiments, the sulfonated polymer is a selectively sulfonated negative-charged anionic block copolymer, which “selectively sulfonated” definition to include sulfonic acid as well as neutralized sulfonate derivatives. The sulfonate group can be in the form of metal salt, ammonium salt or amine salt. In embodiments, the sulfonated block polymer has a general configuration A-B-A, (A-B)ₙ(A), (A-B-A)ₙX, (A-B)ₙX, A-D-B, A-B-D, A-D-B-D-A, A-B-D-B-A, (A-D-B)ₙA, (A-B-D)ₙA (A-D-B)ₙX, (A-B-D)ₙX or mixtures thereof; where n is an integer from 0 to 30, or 2 to 20 in embodiments; and X is a coupling agent residue. Each A and D block is a polymer block resistant to sulfonation. Each B block is susceptible to sulfonation. For configurations with multiple A, B or D blocks, the plurality of A blocks, B blocks, or D blocks can be the same or different.

In embodiments, the A blocks are one or more segments selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof. If the A segments are polymers of 1,3-cyclodiene or conjugated dienes, the segments will be hydrogenated subsequent to polymerization of the block copolymer and before sulfonation of the block copolymer. The A blocks may also contain up to 15 mol % of the vinyl aromatic monomers such as those present in the B blocks.

In embodiments, the A block is selected from para-substituted styrene monomers selected from para-methylstyrene, para-ethylstyrene, para-n-propylstyrene, para-iso-propyl styrene, para-n-butyl styrene, para-sec-butyl styrene, para-iso-butyl styrene, para-t-butylstyrene, isomers of para-decylstyrene, isomers of para-dodecylstyrene and mixtures of the above monomers. Examples of para-substituted styrene monomers include para-t-butylstyrene and para-methylstyrene, with para-t-butylstyrene being most preferred. Monomers may be mixtures of monomers, depending on the particular source. In embodiments, the overall purity of the para-substituted styrene monomers be at least 90%-wt., or >95%-wt., or >98%-wt. of the para-substituted styrene monomer.

In embodiments, the block B comprises segments of one or more polymerized vinyl aromatic monomers selected from unsubstituted styrene monomer, ortho-substituted styrene monomers, meta-substituted styrene monomers, alpha-methylstyrene monomer, 1,1-diphenylethylene monomer, 1,2-diphenylethylene monomer, and mixtures thereof. In addition to the monomers and polymers noted, in embodiments the B blocks also comprises a hydrogenated copolymer of such monomer (s) with a conjugated diene selected from 1,3-butadiene, isoprene and mixtures thereof, having a vinyl content of between 20 and 80 mol percent. These copolymers with hydrogenated dienes can be any of random copolymers, tapered copolymers, block copolymers or controlled distribution copolymers. The block B is selectively sulfonated, containing from about 10 to about 100 mol % sulfonic acid or sulfonate salt functional groups based on the number of monomer units. In embodiments, the degree of sulfonation in the B block ranges from 10 to 95 mol %, or 15-80 mol %, or 20-70 mol %, or 25-60 mol %, or >20 mol %, or >50 mol %.

The D block comprises a hydrogenated polymer or copolymer of a conjugated diene selected from isoprene, 1,3-butadiene and mixtures thereof. In other examples, the D block is any of an acrylate, a silicone polymer, or a polymer of isobutylene with a number average molecular weight of >1000, or >2000, or >4000, or >6000.

The coupling agent X is selected from coupling agents known in the art, including polyalkenyl coupling agents, dihaloalkanes, silicon halides, siloxanes, multifunctional epoxides, silica compounds, esters of monohydric alcohols with carboxylic acids, (e.g. methylbenzoate and dimethyl adipate) and epoxidized oils.

The antimicrobial and mechanical properties of the sulfonated block copolymer can be varied and controlled by varying the amount of sulfonation, the degree of neutralization of the sulfonic acid groups to the sulfonated salts, as well as controlling the location of the sulfonated group(s) in the polymer. In embodiments and depending on the applications, e.g., one with the need for water dispersity/solubility, or at the other spectrum, one with the need for sufficient durability with constant wiping with water based cleaners, the sulfonated block copolymer can be selectively sulfonated for desired water dispersity properties or mechanical properties, e.g., having the sulfonic acid functional groups attached to the inner blocks or middle blocks, or in the outer blocks of a sulfonated block copolymer, as in U.S. Pat. No. 8,084,546, incorporated by reference. If the outer (hard) blocks are sulfonated, upon exposure to water, hydration of the hard domains may result in plasticization of those domains and softening, allowing dispersion or solubility.

The sulfonated copolymer in embodiments is as disclosed in Patent Publication Nos. U.S. Pat. Nos. 9,861,941, 8,263,713, 8,445,631, 8,012,539, 8,377,514, 8,377,515, 7,737,224, U.S. Pat. Nos. 8,383,735, 7,919,565, 8,003,733, 8,058,353, 7,981,970, 8,329,827, 8,084,546, 8,383,735, U.S. Ser. No. 10/202,494, and U.S. Ser. No. 10/228,168, the relevant portions are incorporated herein by reference.

In embodiments, the sulfonated block copolymer has a general configuration A-B-(B-A)₁₋₅, wherein each A is a non-elastomeric sulfonated monovinyl arene polymer block and each B is a substantially saturated elastomeric alpha-olefin polymer block, said block copolymer being sulfonated to an extent sufficient to provide at least 1% by weight of sulfur in the total polymer and up to one sulfonated constituent for each monovinyl arene unit. The sulfonated polymer can be used in the form of their acid, alkali metal salt, ammonium salt or amine salt.

In embodiments, the sulfonated block copolymer is a sulfonated polystyrene-polyisoprene-polystyrene, sulfonated in the center segment. In embodiments, the sulfonated block copolymer is a sulfonated t-butylstyrene/isoprene random copolymer with C═C sites in their backbone. In embodiments, the sulfonated polymer is a sulfonated SBR (styrene butadiene rubber) as disclosed in U.S. Pat. No. 6,110,616 incorporated by reference. In embodiments, the sulfonated polymer is a water dispersible BAB triblock, with B being a hydrophobic block such as alkyl or (if it is sulfonated, it becomes hydrophilic) poly(t-butyl styrene) and A being a hydrophilic block such as sulfonated poly(vinyl toluene) as disclosed in U.S. Pat. No. 4,505,827 incorporated by reference. In embodiments, the sulfonated block copolymer is a functionalized, selectively hydrogenated block copolymer having at least one alkenyl arene polymer block A and at least one substantially completely, hydrogenated conjugated diene polymer block B, with substantially all of the sulfonic functional groups grafted to alkenyl arene polymer block A (as disclosed in U.S. Pat. No. 5,516,831, incorporated by reference). In embodiments, the sulfonated polymer is a water-soluble polymer, a sulfonated diblock polymer of t-butyl styrene/styrene, or a sulfonated triblock polymer of t-butyl styrene-styrene-t-butyl styrene as disclosed in U.S. Pat. No. 4,492,785 incorporated by reference. In embodiments, the sulfonated block copolymer is a partially hydrogenated block copolymer.

In embodiments, the sulfonated polymer is a midblock-sulfonated triblock copolymer, or a midblock-sulfonatedpentablock copolymer or, e.g., a poly(p-tert-butylstyrene-b-styrenesulfonate-b-p-tert-butylstyrene), or a poly[tert-butylstyrene-b-(ethylene-alt-propylene)-b-(styrenesulfonate)-b-(ethylene-alt-propylene)-b-tert-butylstyrene.

In embodiments, the sulfonated polymer contains >10 mol %, >15 mol %, or >25 mol %, or >30 mol %, or >40 mol %, or >60 mol % sulfonic acid or sulfonate salt functional groups based on the number of monomer units in the polymer that are available or susceptible for sulfonation, e.g., the styrene monomers.

In embodiments, the sulfonated polymer has an ion exchange capacity of >0.5 meq/g, or >0.75 meq/g, or >1.0 meq/g, or >1.5 meq/g, or >2.0 meq/g, or >2.5 meq/g, or <5.0 meq/g.

Optional Components: In further embodiments, the bio-secure copolymers can be complexed with, or otherwise form mixtures, compounds, etc. with, antibiotics such as butylparaben and triclosan, e.g., antimicrobial surfactants, lipids, nanoparticles, peptides, antibiotics or antiviral drugs, sulfonium containing polymers, quaternary ammonium and phosphonium containing polymers, chitosan and other naturally occurring antimicrobial polymers, ion-exchange resins, metallic-based micro and nanostructured materials such as silver, copper, zinc and titanium and their oxides, for enhanced antimicrobial effectiveness.

In embodiments, the sulfonated polymer comprises additives that would help signal or give an indicator of its antimicrobial effects with a color change pH indicator. Examples include Thymol Blue, Methyl Orange, Bromocresol Green, Methyl Red, Bromothymol Blue, Phenol Red, and Phenol-phthalein. A color change means a change in hue, from a light to a darker color or vice versa. If a color indicator is incorporated, a chart is provided with the bio-secure equipment to indicate if a recharge, regeneration, or reactivation of the antimicrobial activity of the surface is recommended. The color indicator is incorporated in a sufficient amount so that a noticeable change in color hue is observed immediately when there is a change in the effectiveness of the sulfonated polymer. For example, when its pH is raised above a certain level such as 2.0 (different pathogens have different pH responses), the change is known right away. In embodiments, the amount of color indicator ranges from 1 to 20 wt. %, <10 wt. %, or at least 0.1 wt. % of the amount of the sulfonated polymer as the protective coating material.

In addition to the above optional components, other additives such as plasticizers, tackifiers, surfactants, film forming additives, dyes, pigments, cross-linkers, UV absorbers, catalysts, highly conjugated particles, sheets, or tubes (e.g. carbon black, graphene, carbon nanotubes), etc. can be incorporated in any combination to the extent that they do not reduce the efficacy of the material.

Method for Forming Bio-Secure Material: The sulfonated polymer can be provided in the form of crumbs, films, membranes, fiber, solutions, or dispersion in water or solvent, for subsequent coating onto the equipment surfaces. In embodiments, the sulfonated polymer prior to application is subject to a washing process by rinsing in deionized water or alcohol to remove acidic impurities, e.g., to levels of less than 1000 ppm, or until the bulk pH of the water remains consistent within 0.1 pH.

In some embodiments, the sulfonated polymer is provided in the form of a film, sheet, coating, band, strip, profile, molding, extruded article, printed pieces and parts, foam, tape, fabric, thread, filament, ribbon, fiber, plurality of fibers or, fibrous web. In embodiments, the sulfonated polymer is in the form of films, or membranes having a thickness of 0.1-100 μm, or >5 μm, or >20 μm, or >25 μm, or <100 μm, or <1000 μm.

The sulfonated polymer can be formed by a variety of processes such as for example casting, injection molding, over molding, dipping, extrusion, roto molding, slush molding, fiber spinning (such as electrospinning), film making, 3-D printing, painting or foaming.

Methods for Applying Bio-Secure Material Onto Protective Equipment: The bio-secure material can be applied onto surfaces of equipment in a suitable carrier, e.g., as a liquid, a gel, a foam, a spray, an emulsion, a solution (sterilizing or disinfecting), a thin film, a laminate (by wet bonded, thermally bonded, or adhesively bonded), forming a coating layer having sufficient surface thickness for prolonged bio-secure properties.

Depending on the ion exchange capacity (IEC) or the pH of the sulfonated polymer, or the intended use (e.g., microbial activities), in embodiments, the sufficient thickness for a protective/antimicrobial coating is at least 0.1 μm, or >1 μm, or >5 μm, or >10 μm, or <200 μm, or <500 μm, or <1000 μm, for a surface capable of killing or inactivating microbes, e.g., prevent the formation of a biofilm on the surface.

In embodiments depending on the degree of sulfonation and the selective sulfonation, the sulfonated polymer is water dispersible, or soluble in organic solvents.

The carrier comprising the sulfonated polymer can be applied onto surfaces by equipment including but not limited to any of a dispenser, a spray applicator, or a solid support or a substrate soaked with or coated with the carrier comprising the sulfonated polymer. The solid support or the equipment surface can be any of wood, metal, a woven or non-woven fabric, a textile, an absorbent sheet, etc. The material can be applied by methods including but not limited to dip coating, spray coating, electro-spinning, printing (including 3-D printing), laminating, spin-coating, extruding, or extrusion then followed by blow-molding.

The application method depends on the nature of the article/surface to be coated, and the application environment (e.g., a hospital, a workshop, etc.). Different application methods with different carriers can be employed as disclosed in U.S. Pat. No. 10,047,477, incorporated herein by reference. In a manufacturing environment where vapors from solvents can be controlled and contained, various organic solvents can be considered. The solvents can include one or more aprotic polar solvents including ethers, amides, esters, ketones, nitriles, tertiary amines, sulfates and sulfoxide. In embodiments, the sulfonated polymer is applied as a solution containing aliphatic hydrocarbons like cyclohexane, in aromatic hydrocarbons like toluene, in alcohols like methanol, ethanol, propanol, benzyl alcohol and the like, in various carbonyl solvents like methylethylketone, acetone, etc., or in a nitrogen containing solvents like N-methyl pyrolidone, N,N-dimethyl acetamide, pyridine, etc. In embodiments, mixtures of solvents can be used as long as homogeneous solutions or stable suspensions in the presence of the sulfonated polymer can be made.

In applications outside of a manufacturing location, e.g., hospital workshops, etc., coating from aqueous emulsions and dispersions is preferred, e.g., with aqueous dispersions or aqueous emulsions as disclosed in U.S. Pat. No. 10,047,477, incorporated by reference.

In one embodiment with an article to be coated being relatively small, or with solid surfaces, the article is dip-coated. The article is immersed in a solution or emulsion of the bio-secure polymer, then removed to allow the solvent to evaporate, for an antimicrobial coating.

In embodiments, the article is spray-coated. Spray coating can be an efficient route to covering large areas with the antimicrobial polymer coating. For spray coating, the sulfonated polymer is dispersed in the liquid carrier until a sufficient viscosity suitable for spraying is obtained. In many solvents, a desired viscosity is obtained with a polymer concentration of <20 wt. %, or <10 wt. %, or <6 wt. %, or >1 wt. %, or 1-12 wt. %, or 1-8 wt. %, or 2-8 wt. %. In embodiments of spray coating, the solvents in the polymer on the surface of the spray coated article can be released (evaporate) at room temperature. In other embodiments, the article is heated to a temperature of <150° C., or <130° C., or <100° C. and >50° C. to accelerate the evaporation of the solvent, and give the article a uniform coating that is pleasing in appearance.

In embodiments, the sulfonated polymer is applied as printed patterns onto surfaces of an article using standard printing technologies, e.g., such as gravure printing, screen printing, transfer printing, or flexographic printing for coating surfaces with the antimicrobial polymer solutions. In transfer printing, the printing solution is applied to a paper or silicone substrate which is then contacted with the fabric or other substrate and the print pattern is “transferred” from the original substrate to the final substrate.

The printing technique is dependent on the solution viscosity. In embodiments, the sulfonated polymer is dispersed in a liquid carrier, e.g., an organic solvent or an aqueous solution, for a solution having a viscosity of >3000 centipoise. After printing, the printed article is dried at temperatures ranging from ambient to 150° C., or 130° C., or 100° C., with the drying temperature being dependent on the stability of the substrate to elevated temperatures.

Depending on the article or equipment to be coated, in embodiments, the antimicrobial coating can be applied as a continuous pattern or a discontinuous pattern. The patterned application can be applied via printing methods known in the art, and particularly when the surface of the article is porous or is not flat, as with woven or non-woven textile or fabric. For fabric articles, the printing method allows a straightforward method for controlling the coat weight. After printing, other processes such as calendaring can also be applied to improve durability or adhesion of the bio-secure coating.

In embodiments, a lamination method is employed with the use of pre-formed sulfonated polymers in the form of sheets, films, membrane, scrims, or patterns. Lamination can be done with heat or with adhesives. In embodiments with metal surfaces, lamination is used with water or solvent for laminating a layer, or layers of the sulfonated polymer onto surfaces for antimicrobial effects. The adhesion is particularly strong in embodiments where the sulfonated polymer, e.g., a film, is exposed to water to obtain a partially or fully hydrated film first prior to applying to a polar surface or a metal surface. Strong adhesion can also be obtained in embodiments where the metal surface to be coated is first wetted prior to the placement of the bio-secure membrane or film.

In embodiments for applying thin layers of sulfonated polymers onto flat surfaces, spin-coating is used for forming a uniform thin film on the equipment. In embodiments with the sulfonated polymer being in the form of fiber, the sulfonated polymer can be formed on surfaces of equipment, or weaved into other materials to form the equipment itself, e.g., fabric for use in tents, surgical supplies, etc. with methods known in the art such as fiber spinning, or electro-spinning.

In some embodiments, the sulfonated polymer is applied first as a coating on a pre-form, for subsequent processing of the pre-form, e.g., blow-molding such as with a container, for a thin layer coating on the container which still remains transparent or clear.

In embodiments, the sulfonated polymer is applied as layer-by-layer films or as multi-layer coatings. Some applications employ one or more polycation layers and one or more polyanion layers, for pH responsive controlled release of the polycation, thus enhancing its bio-secure effectiveness. The polycation layers in embodiments may comprise chitosan. The polyanion layers in embodiments comprise the same or different negative-charged anionic sulfonated block copolymers, or poly(methacrylic acid), and/or poly(methyl methacrylic acid). In some embodiments, the polycation layers comprise one or more sulfonated polymers as described above, e.g., quaternary ammonium polymers or phosphonium polymers. A method to enhance or modify the sulfonated polymer is disclosed in “Applicability of a New Sulfonated Pentablock Copolymer Membrane and Modified Gas Diffusion Layers for Low-Cost Water Splitting Processes,” Energies 2019, 12, 2064, incorporated by reference.

In embodiments, the sulfonated polymer is applied in layers with other polymers, e.g., passive polymers for enhanced microbial activities. Passive polymers refer to polymers that reduce protein adsorption on its surface, thereby preventing the adhesion of microbes. They repel microbes, although they do not necessarily interact with or kill microbes. Examples include slippery liquid infused porous surface (SLIPS) materials such as poly(dimethylsiloxane); uncharged polymers such as poly(ethylene glycol) (PEG), polypeptoid, poly(n-vinyl-pyrrolidone), polyethylenimene and poly(dimethyl acrylamide); and charged polyampholytes and zwitterionic polymers such as phosphobetaines and sulfobetaines.

In some applications instead of layering, the passive polymer is used to modify the sulfonated polymer, e.g., forming a polyethylene glycol-modified sulfonic polymer. Another example of modifying the sulfonated polymer is with polyetherimide, for a sulfonated polymer/polyetherimide composite. In embodiments, the sulfonated polymer is applied as a coating layer on top of layer(s) containing slow-release anti-microbial materials, e.g., silver, nanoparticles complexes, etc., for a dual-mechanism anti-microbial protection.

In embodiments with the use of sulfonated polymer n neutralized form, articles can be formed directly from the sulfonated polymer, with the articles being formed by processes known in the art such as extrusion, injection molding, over-molding, slush molding, roto-molding, or 3-D printing. In embodiments, with the use of different solvents, or solvent mixture that comprises two or more solvents selected from polar solvents and non-polar solvents, the anti-microbial properties of coating material can be tailored for the specific application.

In embodiment, the sulfonated polymer is applied as a coating layer for polar surfaces or activated metal surfaces, as disclosed in US Patent Application No. US20200071447A1, incorporated herein by reference, a film of sulfonated polymer is first sprayed with water or subject to water vapor by jets or mists. After drying to form a laminate, the coating layer does not delaminate from the substrate even after being exposed to humidity of up to 85% for a duration of at least 72 hours.

Properties—Anti-microbial Capability: The sulfonated polymer can be used for the sterilization/disinfection of microbes, e.g., upon contact with contaminated surfaces such as human or animal skin, microbes in respiratory droplets from individuals carrying infectious and/or contagious diseases, microbes in fecal matters of animal or human. The sulfonated polymer is capable of killing the microbes themselves, or working in conjunction with known therapy.

In embodiments, the sulfonated polymer is characterized as being sufficiently sulfonated to have an IEC of >0.5 meq/g, or 1.5-3.5 meq/g, or >1.25 meq/g, or >2.2 meq/g, or >2.5 meq/g, or >4.0 meq/g, or <4.0 meq/g.

In embodiments, the sulfonated polymer is characterized as having a surface pH of <3.0, or <2.5, or <2.25, or <2.0, or <1.80. It is believed that a sufficiently low surface pH level, as a result of the presence of sulfonic acid functional groups, kills microorganisms that come in contact with surface, including bacteria, viruses, algae, mold, mildew, and fungi in the environment (e.g., air or water).

Not wishing to be limited by the following mechanism, it is believed that a sufficiently low surface pH level, as a result of the presence of sulfonic acid functional groups in the coating material, would have catastrophic effects on microbes that come in contact with the surface. It has been studied and shown that pH has an effect on bacteria, with bacteria being classified according to their preferred pH range: acidophiles (1.0-5.5), neutrophils (5.5-8.0), and alkalophiles (>8.0). Although bacteria can thrive in environments at different pH levels, they tend to maintain a neutral interior irrespective of the external pH. A sudden change in pH, however, promotes stress on the outer membrane and destroys the membrane, resulting in enzyme damage, protein denaturation and microbe death.

As an alternative potential mechanism, it is possible that the functional groups in the sulfonated polymer, e.g., sulfonate ester functional groups, the sulfonic acids, etc., interact with the functionality in the microbes and deactivate the microbe. For example, in the context of SARS-CoV-2 virus, the sulfonated polymer with exposed ionic domains in the functional groups is expected to immobilize/sequester via interactions with the spike glycoproteins as they are sugar coated and thus highly polar.

In embodiments, the sulfonated polymer works effectively in destroying/inactivating at least 99%, or at least 99.5%, or at least 99.9%, or at least 95%, or at least 90% of microbes within 120 minutes, 60 minutes, 30 minutes of exposure, or within 5 minutes of exposure, for microbes including but not limited to SARS-CoV-2 virus, MRSA, X-MulV, PI-3, vancomycin-resistant Enterococcus faecium, carbapenem-resistant Acinetobacter baumannii, and influenza A virus. In embodiments with copolymer containing quaternary ammonium group, the material is effective in killing target microbes including Staphylococcus aureus, Escherichia coli, Staphylococcus albus, Escherichia coli, Rhizoctonia solani, and Fusarium oxysporum.

The sulfonated polymer remains effective in killing microbes even after 4 hours, or after 12 hours, or at least 24 hours, or at least 48 hours. In embodiments, the sulfonated polymer remains effective in killing microbes for at least 3 months, or for at least 6 months.

Depending on the final application and/or the type of support layer/the surface to be protected, for antimicrobial effect, in embodiments, the sulfonated polymer is applied for a protective layer of less than 1000 μm, or >1 μm, or >5 μm, or >10 μm, or <500 μm, or <200 μm, or <100 μm, for a self-sterilizing surface.

In addition to the self-sterilizing properties, in embodiments with the sulfonated polymer being a sulfonated block copolymer, e.g., a pentablock copolymer, a film comprising the sulfonated polymer also exhibits anti-fog property, having a T_{fog} of >5 minutes, i.e., no fog is formed on a surface of said coating within about 5 minutes. In embodiments, the T_{fog} is at least 15 minutes, or at least 30 minutes.

Activation/Recharging/Enhancing: The sulfonated polymer is characterized as having anti-microbial characteristics as well as having a “smart” response to changes in levels of humidity. In the presence of moisture, at high levels of humidity, the sulfonated polymer presents a surface that is covered with polymer-bound acid functionality, i.e., being strongly acidic. Strongly acidic surfaces, such as sulfonic acid, can be deadly for many microbes, e.g., viruses. In embodiments and depending on the initial functionalization levels, e.g., sulfonation, phosphonization, etc., in an arid environment and at a low level of humidity, the acid functionality retracts away for the surface of the film. In this way, the acid functionality is protected from environmental contamination while the surface is in the dormant state or the dry state. The process can be reversible by activation or regeneration.

In embodiments, the active surface can be recharged with rearrangement of the chemistry at the surface in the presence of moisture in air. It should be noted that for sulfonated polymer with a high anti-microbial activities to start with, e.g., a sulfonation level of 90+% of the functionalized block, recharge or activation is not necessary or with less frequency than with a surface with a lower initial anti-microbial activities or lower sulfonation level. In embodiments, the surface can be regenerated by rearrangement, e.g., by exposure to a strong acid having a concentration of >0.1M, or >0.5M, or >0.75M, or >1M for a sufficient amount of time. In embodiments, the exposure is for >5 minutes, or >30 minutes, or 10-45 minutes, or >1 hr.

Not wishing to be limited by the following mechanism, it is believed that the ion containing phase of the sulfonated polymer, such as a sulfonated block copolymer from Kraton Corporation, is exposed at the surface of a protective surface such as a film at high humidity levels. In the presence of a condensed water phase and as a direct consequence, there is selective swelling of the ion containing phase by condensed water or water vapor at the surface. As the water is adsorbed selectively into the acid containing segment of the sulfonated polymer, e.g., sulfonic acid, the not-sulfonated portion of the sulfonated polymer absorbs an insignificant amount of water, the volume of the sulfonic acid containing phase increases significantly at the expense of the rest of the polymer. As the not-sulfonated portion of the sulfonated block copolymer, is rigid, the sulfonic acid containing portion of the polymer can only expand in volume by “blooming” to the surface of the coating. As such, the surface of the sulfonated polymer is covered with the exceptionally acid moieties for the surface to become toxic for a variety of microbes.

Bio-Secure Applications: Due to the enduring bio-secure properties of the sulfonated polymer capable of killing microbes/rendering them inert, or inhibiting the attachment of microbes to equipment with the application of just a thin layer of surfaces to be protected, the sulfonated polymer is particularly suitable for use in the protection from pathogens. Examples of equipment for coating with the sulfonated polymer include but are not limited to medical equipment, articles and gear for use by hospitals, surgical supplies (e.g., wound dressings, gels, etc.), medical/safety devices for use in medical facilities or by health care workers (e.g., face shields), public safety personnel, or general protective gear for all (e.g., face masks, gloves, etc.). For hospital environments as well as healthcare facilities and residences, especially for the protection of those with debilitated immune systems, the sulfonated polymer can be applied as a solution for spraying whenever and wherever needed, particularly high-touch surfaces, for an immediate/emergency anti-microbial application with long lasting effects, e.g., at least a few hours, obviating the need for repeated cleaning after each exposure to microbial activities. In yet other embodiments, strips of bio-secure polymer films or membranes can be applied onto metal surfaces in medical facilities, public buildings, creating self-adhered anti-microbial surfaces, which also serve to prevent unwanted biofilm formation.

The sulfonated polymer can be applied onto fibers, tubes, fabrics, sheets, coatings for woven and non-woven fabrics and laminates, for use in applications including but are not limited to, patient examining booths, breathable protective clothing and gloves for first responders, fire fighters, chemical and biological workers, agricultural workers, medical employees, and military personnel involved in handling or being in contact with potentially hazardous and/or infectious materials; sports and recreational clothing, tenting; selective membranes for industrial, medical and water purification applications.

Other applications contemplated for the use of the sulfonated polymer include but are not limited to cleaning equipment (e.g., brush bristle, cleaning cloth); food packaging such as films or containers; food processing such as conveyer belt for transporting food; gloves, head gear, garments and aprons for use in food processing industry, kitchens and restaurants; military tents; hospital tents; filters for use in energy recovery units, humidifiers/dehumidifiers/air conditioners/air filtering equipment for home use or public buildings, hospitals, and facilities, filter to process air in sterile environments, vehicular ventilation systems; self-sterilizing fabrics (including clothing and garments for personal or medical patient use), as well as furniture and furniture components such as counter-tops, table tops, cushions, fillers, and padding for residential, healthcare or commercial use; personal hygiene articles such as single-use specialty diapers, pads and hygiene items particularly for individuals with immune system deficiency; maintenance materials such as incorporation into paint for use in painting hospitals or medical facilities, incorporation into wood composite materials for buildings; contact surfaces for use by members of the public, e.g., electronics, hand rails, stair cases, door knobs, door handles, faucets, automotive and aircraft interiors, luggage and hand bags, activation buttons or push plates for automatic doors, light switches, elevator buttons, gas pump handles, shopping cart handles, door mats, furniture, (credit) cards and card readers, wallets, keys, counters and containers, office supplies such as pens, markers, rulers, touch screens, monitor screens (e.g., kiosk, automatic teller machines, casino machines, etc.), among many other surfaces/articles.

In embodiments, the sulfonated polymer is applied in a peel-and-stick form, as a film for adhering to surface (electrostatically or adhesively) for the applications described above. In one example, the sulfonated polymer is applied as a releasable thin layer onto surfaces of plastic face shields, which can be reused again and again if periodically reactivated or regenerated if desired.

In embodiments, the sulfonated polymer is applied onto textile materials or can be made into textile materials, for the construction of masks, surgical gowns, medical tents, cots for patients, etc., facilitating the construction of mobile hospitals or medical centers. The application of the sulfonated polymer in medical care equipment allows for continuous/extended treatments of patients without the need for sterilization after each patient's visit. The material can also be employed to cover surfaces of an examination room/isolation unit, with all surfaces being exposed to the patient being coated with a layer of the sulfonated polymer or constructed from sulfonated polymer materials, with the attending medical personnel being shielded behind a laminate or glass layer coated by the material and examining or handling the patients with the use of glovebox also coated with the sulfonated polymer. The unit can be provided with a negative or positive pressure ventilation for protection of medical personnel. The bio-secure surface, e.g., fabric, metal, etc., after exposure to patients can be reactivated as needed to restore the degree of sulfonation/IEC/antimicrobial activities of the sulfonated polymer.

The sulfonated polymer is applicable for use in protective facemasks, particularly with airborne transmission of infectious particles expelled from the respiratory tract of an infected person by coughing, sneezing, or by simple exhalation, and into the gastrointestinal or respiratory systems of a previously non-infected person by inhalation. The sulfonated polymer can be made into fiber or microfiber used in making the cover web or filters in the facemasks. The sulfonated polymer can also be used for coating, or fabricated into woven or nonwoven fibers or fabric for use in the facemasks. In embodiments, in addition to coating the fabric portion (e.g., the pleated textile portion) of facemasks, the sulfonated polymer can also be used for coating the transparent portion/shield of a facemask. In one embodiment for a facemask with a replaceable filtering structure, the sulfonated polymer is for the coating for the entire exposed surface (the reusable portions or the respirator components) of the facemask, as well for the filtering layers. In embodiments, the sulfonated polymer is used for the coating on one of the multiple fabric layers for use in a facemask, e.g., a non-woven polypropylene layer, with the other layers in the facemask being treated or coated with other anti-microbial compositions, e.g., metal salts such as zinc acetate, copper acetate, etc.

Examples: The following examples are intended to be non-limiting.

Surface pH can be measured using a triple-point calibrated flat electrode pH meter, with precision of 0.01 pH at 20° C., with the samples being pre-conditioned for at least 24 hours at 20° C. and 50% relative humidity, and measurements are taken by gently pressing the film sample against the electrode until readings become stable to 0.1 pH values. Alternatively, samples that are pre-conditioned can be exposed to a droplet of deionized water, e.g., 30-60 μl, for 60 seconds, at which point the flat electrode pH meter is used to gauge pH of the sample interface with the water droplet.

Example 1: In this example, a sulfonated block copolymer emulsion is prepared, that can be subsequently used for coating surfaces, e.g., equipment, textile, etc. A polymer solution comprising a mid-block sulfonated pentablock copolymer with a sulfonation level of 52 mol % is mixed with a sufficient amount of acetone, methyl ethyl ketone (MEK) or tetrahydrofuran (THF). Water is added to the mixture (ratio of 1.5:1 water to copolymer mixture) and the emulsion is recirculated over a static mixer/roto stator at rate of 100 kg/hr. The solvent is subsequently stripped off under vacuum and slight N2 through-flow at a slow drop, e.g., 900 mbar to 350 mbar over time, for a concentrated emulsion which can be subsequently diluted in water for coating articles as needed for a bio-secure surface.

Example 2: This example is to illustrate the mechanism behind the activation of a sulfonated polymer by exposure to a moist environment. A triblock copolymer containing sulfonation resistant endblocks from the polymerization para-tent-butyl styrene and a center segment of polymerized styrene was sulfonated under conditions where the polystyrene segment was selectively sulfonated with acetyl sulfonate as sulfonating agent. The selectively mid-block sulfonated copolymer was cast (from a THF/MeOH (90/10 (wt/wt) solvent blend) into a film. The dry film was separated into 2 parts. One part of the film was examined as cast, “dry” using an Atomic Forces Microscopy, AFM. The second portion of film was immersed in water and then examined using the AFM technology (“hydrated”).

It is observed that the surface of the “dry” film is flat and featureless. The sulfonic acid portion of the block copolymer has receded away from the surface of this film and is not “observed” at the surface of the material by the tapping AFM tip. On the other hand, the AFM tip finds the hydrated film to have a continuous (see light in color honeycomb pattern), water swollen, sulfonic acid phase that rises high (perhaps as much as 100 nm) above the surface of the rigid portion of the material. In this way, the sulfonic acid portion of the material is activated, thus available to kill microbes.

Example 3: The example was conducted to evaluate the effectiveness in inhibiting Aspergillus niger black mold according to the AATCC Test Method 30-2004 Test III. Six different sulfonated block copolymer membrane samples comprising a poly[tert-butylstyrene-b-(ethylene-alt-propylene)-b-(styrenesulfonate)-b-(ethylene-alt-propylene)-b-tert-butylstyrene], at different levels of sulfonation from 26 to 52% were used for the tests. Aspergillus niger, ATCC #6275, was harvested into sterile distilled water containing glass beads. The flask was shaken to bring the spores into suspension. The suspension was used as the test inoculum. One (1.0) mL of the inoculum was even distributed over the surface of Mineral Salts Agar plates. The membrane samples were placed onto the inoculated agar surface. After placement, 0.2 mL of the inoculum was distributed over the surface of each disc. A viability plate of the spore suspension was prepared on Mineral Salts Agar with 3% glucose. A positive growth control was prepared using an untreated cotton duck fabric on Mineral Salts Agar and set up in the same manner as the test items. All samples were incubated at 28° C.±1° C. for 14 days.

The viability plate had acceptable fungal growth as expected confirming the viability of the inoculum. The sample with 26% sulfonation showed microscopic growth on 10% of the sample surface. The other 5 test samples showed no growth, or microscopic growth on 1% of the surface. The control sample showed macroscopic growth on 100% of the surface.

Example 4: A number of examples are carried out to evaluate the removal/inactivation of viruses including Xenotropic Murine Leukemia virus (X-MulV) with a size of 70-100 nm and Paramyxo (PI-3) with a size 100-250 nm, with 1% spike on a midblock-sulfonated pentablock copolymer with 52% sulfonation (a poly[tert-butylstyrene-b-(ethylene-altpropylene)-b-styrenesulfonate-b-(ethylene-all-propylene)-b-tert butyl styrene]). X-MulV is selected to represent a non-defective C type retrovirus, demonstrating the virus inactivation capability of the sulfonated polymer. The temperature is set at ambient (23° C.±2° C.), with a 0.5 ml virus per run, and acidic condition for the sulfonated polymer. The incubation time is set at 5 minutes.

In the experiments, the copolymer was redissolved in THF and cast into film. The film was cut into discs fitting into a well of flat-bottom 6 or 12 well plates. 5004, of X-MuLV and PI-3 was added to each disc in duplicate separately. For the runs with PI-3, the virus report titer is TCID50 units per ml. The volume adjust is 0.5 mil. The dilution adjust is 5.0 mil. The following table summarizes the test with PI-3 after 2 runs, with a virucidal efficiency of 99.9917% within 5 minutes.

| | | Adjusted | | |
|---|---|---|---|---|
| | | Titer | | % |
| | Average | Log 10 | % | Inacti- |
| Description | Titer | TCID50/mL | Recovery | vation |
| Load Sample (T = 0 min) | 8.82E+05 | 5.95 | NA | NA |
| Hold Control (T = 5 min) | 7.17E+05 | 5.86 | NA | NA |
| T = 5 min sample | 7.32E+01 | 1.86 | 0.0083 | 99.9917 |
| Media Control | NA | NA | NA | NA |

For the runs with X-MulV, plaque assay was used (PFU with results in PFU/mL). The following table summarizes the experiments with 2 runs, showing a virucidal efficiency of 99.9997% against X-MulV within 5 minutes.

| | | Adjusted | | |
|---|---|---|---|---|
| | | Titer | | |
| | Average | Log 10 | % | % |
| Description | Titer | PFU/ml | Recovery | Inactivation |
| Load Sample (T = 0 min) | 1.75E+06 | 6.24 | NA | NA |
| Hold Control (T = 5 min) | 1.50E+06 | 6.18 | NA | NA |
| T = 5 min sample | 5.00E+00 | 0.70 | 0.0003 | 99.9997 |
| Media Control | NA | NA | NA | NA |

The following summarizes the results expressed in Log values:

| | | | | Average | |
|---|---|---|---|---|---|
| | | | Linear | Linear | Average |
| | Run | Log₁₀ | value of | value of | Log₁₀ |
| Virus | No. | Reduction | reduction | reduction | Reduction |
| PI-3 | Run 1 | 4.00 | 10000.00 | 12227.20 | 4.09 |
| | Run 2 | 4.16 | 14454.40 | | |
| X-MuLV | Run 1 | 5.52 | 333000.00 | 349850.00 | ≤5.54 |
| | Run 2 | 5.56 | 366700.00 | | |

Example 5: The example is to illustrate dependency of coating thickness on the coating time (residence time exposed to bio-secure solution). A number of bio-secure solutions were prepared by dissolving a membrane comprising a mid-block sulfonated pentablock copolymer, a poly[tert-butylstyrene-b-(ethylene-altpropylene)-b-styrenesulfonate-b-(ethylene-all-propylene)-b-tert butylstyrene] with 52% sulfonation in a solution of toluene/1-propanol at a ratio of 1:1 for a bio-secure concentration of 22 wt. %, the Brookfield viscosities of the compositions range from 3450 to 3700 cps, varying depending on the mixing shear rate of the equipment. Another bio-secure solution was also prepared by dissolving the sulfonated block copolymer in cyclohexane for a concentration of 11 wt. %.

In one set of examples, the 22 wt. % and 11 wt. % solutions were poured into a number of beverage bottles (made out of PET) and left in the bottle for 15 seconds or 1 minute residence time. After 15 seconds or 1 min., the bottles were emptied and then air dried for 24 hours. There is minimal variation (less than 10%) in coating thickness for bottles coated for 1 minute vs. 15 seconds.

Example 6: A number of 22 wt. % solutions were made with mid-block sulfonated pentablock copolymers at different sulfonation levels. Formulation #1 with 18 wt. % copolymer having 52 mol % sulfonation in toluene/1-propanol at 1:1 ratio; Formulation #3 with 11 wt. % copolymer having 52 mol % sulfonation in cyclohexane; Formulation #5 with 14.5 wt. % copolymer with 26 mol % sulfonation in n-methyl-2-pyrrolidone (NMP); Formulation #6 with 11 wt. % copolymer with 26 mol % sulfonation in cyclohexane; and Formulation #7 with 22 wt, % copolymer with 26 mol % sulfonation in toluene/1-propanol at 1:1.

Example 7: The example was to evaluate the pH of the sulfonated polymer over time. The Formulations above were coated onto untreated preforms, i.e., tubing for subsequent blowing into full bottles, by dipping the preforms into the Formulations for about 1 minute, removed and then air dried. The coating thickness on the pre-forms was computed to be about 18 microns. The preforms were blown into full PET bottles, with very clear film/bottles resulting from Formulations 5 and 6. The coating thickness of the sulfonated polymer on the bottle was estimated to be about 4 microns.

A number of 1.5 cm diameter samples were cut from the shoulder and base areas of the bottles. The samples were placed in about 75 ml of a green tea/honey solution with a pH of 3.2, and the surface pH was immediately measured. Results are in Table 1:

TABLE 1

| Example | pH-shoulder | pH-base |
|---|---|---|
| Control no coating | 3.2 | 3.2 |
| Formulation #1 | 1.1 | 1.8 |
| Formulation #3 | 1.8 | 2.8 |
| Formulation #5 | 3.0 | 2.8 |
| Formulation #6 | 1.8 | 2.0 |
| Formulation #7 | 1.3 | 1.8 |
| Formulation #7 with plasma | 2.4 | 2.3 |
| treatment after coating | | |

The differences in surface pH within the same bottle (shoulder vs. base samples) can be due to the thickness and difference in stretch ratio going from of the bottle relative to the pre-form. The same samples were measured again after 1 hr., and the pH in general increased for all in a range of about 2.5-2.7 for untreated Formulations #7, 1, 3 and 6. Formulation 5 pH stayed the same. Surface pH was measured again after 4 h, and no significant difference was measure.

Example 8: In this example, a multi-layer laminate is structured by casting a sulfonated block polymer solution (sulfonated block polymers in toluene/1-propanol at a 1:1 ratio) onto a Mylar sheet of 1 mil thick.

The casting is done on a mechanical casting table with a casting blade, e.g., Elcometer 4340, that controls the thickness, and the speed of solution being casted on a substrate. A set amount of sulfonated polymer, depending on the desired thickness, is poured onto a substrate. A casting blade is pulled over the liquid, creating a uniform thickness over a substrate. The material is next placed in a chamber where the solvent can be slowly evaporated. After all the solvent is evaporated, the casting is complete forming a laminate structure having thickness ranging from 0.0176″ to 0.0003″.

Surface pH of the antimicrobial layer is measured using a surface pH measuring probe. For the pH test, a small drop of water around 0.02 ml is placed on the antimicrobial layer. The probe is placed on top of the water drop and is touched to the surface of the layer, and pH is measured after 5 minutes, giving a pH of 2.0.

Example 9: Various solutions of sulfonated block polymer were prepared by dissolving dried sheets of sulfonated block copolymers from Kraton Corp. in solvent systems of cyclohexane, toluene, or a blend of 1:1 toluene and 1-propanol. Solutions prepared ranged from 1%-20% solids, preferably 5%-8% solids for spraying.

Dilute solutions are poured into the spray cup reservoir of HVLP spray gun, and applied by powering the sprayer with approximately 26 psi of house air and squeezing the sprayer trigger. Coatings are applied onto different substrates, including Plexiglas, Tyvek, non-woven fabrics, surgical masks, N95 masks, medical specimen bags, mylar, stainless steel and other metals, exam gloves, solid surface countertop, decorative graphic laminate film, leather, carpet, HVAC filter media, plastic, cardboard, and glass.

Example 10: In tests evaluation of the long-lasting antiviral properties, film samples of sulfonated penta block copolymer (SPBC) of the structure poly[tert-butylstyrene-b-(ethylene-alt-propylene)-b-(styrene-co-styrene-sulfonate)-b-(ethylene-alt-propylene)-tert-butylstyrene] with 52% sulfonation were cast out of 1:1 mixture of toluene and 1-propanol. The sulfonated polymer film samples were subjected to abrasion testing of 2200 cycles in the presence of 3 common disinfectants: 70% ethanol, benzalkonium chloride, and quaternary ammonia], and exposure to SARS-CoV-2 virus suspension of concentration 10⁷ pfu/ml.

After 2 hours of contact, viable virus was recovered from each sample by washing twice with 500 μl of DMEM tissue culture media containing 10% serum, and measured by serial dilution plaque assay. The results demonstrate that, after abrasion testing representing approximately one year of cleaning (6 disinfectant wipes/day), surface pro Gibco Dulbecco's Modified Eagle Medium (DMEM) is a widely used basal medium for supporting the growth of many different mammalian cells.

Example 11. A polyethylene flat sheet of 0.5 mm thick is chlorosulfonated by immersing for six hours at room temperature in a sulfur dioxide/chlorine gas mixture (3:1 volume ratio) in visible light. The chlorosulfonated polyethylene sheet is then immersed in 1N NaOH at 50° C. for two days to hydrolyze the pendant sulfonyl chloride groups (—SO₂Cl) groups to sulfonic groups (—SO₃Na+). The sulfonic acid form is obtained by treating the sheet with 1N HCl at room temperature for four hours. The sheet is then washed with deionized water and dried under vacuum. The milli-equivalence (meq) of sulfonic acid groups per gram of polyethylene is determined by titration with NaOH and found to be 1.69 meq/g. The sulfonated polyethylene sheet can be cut into appropriate sizes for the protection of surfaces.

Example 12. Dichloromethane (50 mL, 66 gm) and chlorosulfonic acid (between 0.7 and 1.4 gms) are added sequentially to a wide mouth glass bottle (120 mL capacity, 2 inch diameter). 10 mL of this solution are added to dichloromethane (50 mL, 66 gms) in a wide mouth glass jar (410 mL, 3 inch diameter). To this mixture is added a 1 mil (0.001 inch, 0.0025 cm) colorless PPS (Polyphenylene Sulfide) film. The film is allowed to react for various amounts of time at 25° C. while being suspended in the reaction solution. After a variable time of reaction, the black film is then added to distilled water (200 mL) and the film turned light yellow. The film is washed extensively with more water (about 2 liter) and then boiled in water (250 mL) for about 1 hour. The film is then suspended in 1 molar sodium chloride (220 mL) and the amount of sulfonation is determined by titration with 0.01 molar sodium hydroxide to a pH 7 end point. The amount of sulfonation (in meq/g SO₃H) with reaction-time is 0.64 (1 hour), 1.27 (6.5 hours), 1.71 (16 hours), 1.86 (24 hours), 2.31 (48 hours), and 2.6 (60 hours). The sulfonated poly(phenylene sulfide) film can be used for antimicrobial applications as coating materials or as protective films.

Example 13: Woven fabric of nylon 6, 6 fibers is immersed for 5 minutes in a solution of 0.5 g potassium t-butoxide and 0.5 g methanol in 10 ml of DMSO to provide deprotonated amines on the amide nitrogen in the polymer backbone. The deprotonated polymer is immersed in a solution of 0.33 g of sodium 4-bromobenzylsulfonic acid in 3.3. g DMSO (52° C.) to provide a fabric of polyamide fibers having benzylsulfonate groups attached to the surface thereof. The fabric of sulfonated polyamide fiber is washed with deionized (DI) water and dried to provide a fabric that can be made into protective face masks or clothing.

Example 14: A sulfonated polyester fabric is prepared, for use in making face masks, protective clothing, and the like. First a polyester taffeta made of polyester fiber is put into an acid-resistant sealable container. Sulfuric anhydride previously diluted 10 times with nitrogen gas is brought into contact with the polyester cloth for a sulfonated polyester material. The cloth is then washed with water and dried to produce a sulfonated polyester fabric, which can be used to make face mask, clothing, and the like.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. the recitation of a genus of elements, materials or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A coating material that decreases the transmission of one or more than one pathogen by antimicrobial activities, the coating material comprising:
a sulfonated polymer selected from the group of perfluorosulfonic acid polymers, polystyrene sulfonates, sulfonated block copolymers, sulfonated polyolefins, sulfonated polyimides, sulfonated polyamides, sulfonated polyesters, sulfonated polysulfones, sulfonated polyketones, sulfonated poly(arylene ether), and mixtures thereof;
wherein the sulfonated polymer has a degree of sulfonation of at least 10%;
wherein the coating material is applied onto surfaces prone to microbial contamination for a thickness of at least >1 μm;
wherein the coating material kills at least 90% of microbes in <120 minutes of contact with the surfaces having the coating material applied onto.

2. The coating material of claim 1, wherein the sulfonated polymer has an ionic exchange capacity (IEC) of >0.5 meq/g.

3. The coating material of claim 1, wherein the coating material is applied onto surfaces prone to microbial contamination for a thickness of at least >5 μm, and wherein the coating material kills >95% of microbes within 120 minutes of contact after six months of application onto the surfaces.

4. The coating material of claim 1, wherein the sulfonated polymer is selectively sulfonated to contain from 10-100 mol % sulfonic acid or sulfonate salt functional groups based on the number of monomer units or blocks in the sulfonated polymer susceptible to sulfonation, for the coating material to kill at least 95% of microbes within 30 minutes of contact.

5. The coating material of claim 1, wherein the sulfonated polymer is a selectively sulfonated negative-charged anionic block copolymer having a general configuration of: A-B-A, (A-B)n(A), (A-B-A)n, (A-B-A)ₙX, (A-B)nX, A-D-B, A-B-D, A-D-B-D-A, A-B-D-B-A, (A-D-B)ₙA, (A-B-D)ₙA (A-D-B)ₙX, (A-B-D)ₙX or mixtures thereof, wherein
n is an integer from 0 to 30,
X is a coupling agent residue,
each A and D block is a polymer block resistant to sulfonation,
each B block is susceptible to sulfonation,
the A block is selected from polymerized (i) para-substituted styrene monomers, (ii) ethylene, (iii) alpha olefins of 3 to 18 carbon atoms; (iv) 1,3-cyclodiene monomers, (v) monomers of conjugated dienes having a vinyl content less than 35 mol percent prior to hydrogenation, (vi) acrylic esters, (vii) methacrylic esters, and (viii) mixtures thereof;
the B block is a vinyl aromatic monomer, and
the D block is a hydrogenated polymer or copolymer of a conjugated diene selected from isoprene, 1,3-butadiene and mixtures thereof; and
wherein the block B is selectively sulfonated to contain from 10-100 mol % sulfonic acid or sulfonate salt functional groups based on the number of monomer units, for the coating material to kill at least 99% of microbes within 30 minutes of contact.

6. The coating material of claim 1, wherein the coating material to have a surface pH of <3.0.

7. The coating material of claim 1, wherein the sulfonated polymer is neutralized with at least an inorganic or organic cationic salts.

8. The coating material of claim 1, wherein the sulfonated polymer is neutralized with at least a salt selected from ammonium, phosphonium, pyridinium, and sulfonium salts.

9. The coating material of claim 1, wherein the sulfonated polymer is water dispersible.

10. The coating material of claim 1, wherein the sulfonated polymer is a selectively sulfonated negative-charged anionic block copolymer, having at least one alkenyl arene polymer block A and at least one substantially completely, hydrogenated conjugated diene polymer block B, with substantially all of the sulfonic functional groups grafted to alkenyl arene polymer block A for the block A to be a hydrophilic end-block.

11. The coating material of any of claim 1, wherein the coating material is periodically reactivated by exposure to an acidic solution having a concentration of >0.1M for at least 5 minutes.

12. The coating material of any of claim 1, wherein the coating material forms a layer on the surfaces that does not delaminate from the surfaces even after being exposed to humidity of up to 85% and for a duration of at least 72 hours.

13. The coating material of any of claim 1, wherein the coating material is applied onto the surfaces as a peel-and-stick film, a liquid, a gel, a foam, a spray, an emulsion, a solution, a film, a membrane, or a laminate.

14. The coating material of any of claim 1, wherein the coating material is applied onto the surfaces by any of dip coating, spray coating, electro-spinning, printing, 3-D printing, laminating, spin-coating, extruding, extrusion then followed by blow-molding, and combinations thereof.

15. The coating material of any of claim 1, wherein the coating material is first dispersed in water or solvent for subsequent coating onto the surfaces.

16. An article coated by the coating material of any of claim 1, wherein the article is any of facemasks, patient examining booths, medical facilities, surgical gowns, mobile medical tents, contact surfaces for use by members of the public, handrails, door knobs, handles, faucets, automotive and aircraft interiors, luggage pieces, activation buttons, push plates, light switches, elevator buttons, gas pump handles, shopping cart handles, door mats, furniture, card readers, wallets, keys, counters and containers, and office supplies.

17. A method to provide bio-secure protection properties to surfaces prone to microbial contamination for an extended period of time, the method comprising:
applying onto the surfaces a coating layer comprising the coating material of claim 1.
